(19) United States
(12) Patent Application Publication
(10) Pub. No.: US 2002/0073001 A1
(43) Pub. Date: Jun. 13, 2002

(54) System and process for assisting a user to configure a configurable product

(75) Inventors: David Lauriston Palmer, Mission Viejo, CA (US); Thomas Vollmer, Irvine, CA (US)

Correspondence Address: Ted R. Rittmaster, Foley & Lardner, Suite 3500, 2029 Century Park East, Los Angeles, CA, 90067-3021, US

(73) Assignee: ITT Manufacturing Enterprises, Inc.

(21) Appl. No.: 09/861,259

(22) Filed: May 18, 2001

Related U.S. Application Data
(63) Continuation-in-part of application No. 09/737,249, filed on Dec. 13, 2000.

(51) Int. Cl. G06F 17/60

(52) U.S. Cl. 705/29

(57) ABSTRACT

A system assists a user to configure a configurable product by receiving a set of selected options selected by a user of the system. The system determines available options in view of the selected options, wherein available options comprise options that are not directly excluded by the selected options and options that are not commonly excluded by options remaining in view of the directly excluded options. The system then generates a user interface representing available options. An automated process for generating exclusion rules used by the system, and a user interface for the system, are also disclosed.

### RELATED APPLICATIONS

The present disclosure is a continuation-in-part of U.S. patent application Ser. No. 09/737,249, filed Dec. 13, 2000, the entirety of which is incorporated herein by reference.

### FIELD OF THE INVENTION

Embodiments of the invention pertain to a system allowing a user to configure a configurable product.

### BACKGROUND TECHNOLOGY

Many products available today are configurable by the customer. In general terms, this means that the product has a number of attributes for which various options are available. Personal computers are an example of a configurable product. For example, a customer may be allowed to specify a variety of options relating to attributes such as the type of processor, memory, storage devices, and peripherals. Electrical connectors are another example of a configurable a product. For example, a customer may specify options relating to attributes such as gender (e.g. plug vs. receptacle), termination (e.g. cable vs. circuit board, straight vs. right angle), and numbers of signal lines and coaxial lines.

Traditionally, the assembly and distribution of configurable products has been facilitated by the use of configurators. A conventional configurator is a stand-alone computer application, distributed on floppy disk or CDROM, that is used by purchasers of a configurable product to understand the various available options and to configure the product that meets their needs. In response to the information specified by the customer, the configurator can provide information such as product specifications and pricing. Conventional configurators are typically implemented as a simple database of available products that reflects every viable combination of options and all specifications associated with each combination. While such an implementation can provide satisfactory performance for a small universe of products, the size and complexity of the database increases as a function of the number of attributes and their available options. Thus, determining the products that meet a user's specified set of options can require a vast amount of searching. Further, extensive and often duplicative effort may be required to update the database, for example to add or eliminate an option to a product line, since such maintenance typically requires changing every record for every product that is affected by the added or eliminated option, and may also require the addition of an entirely new set of records reflecting every new combination involving the new option. Thus, while a database implementation of a configurator may provide satisfactory performance for a universe of products having a relatively small numbers of attributes and available options, such as a line of personal computers, such a configurator would be prohibitively complex for a large number of products such as electrical connectors, where hundreds of options relating to potential combinations of thousands of connector components yield a product line that potentially includes millions of unique products.

E-commerce systems typically employ an Internet accessible server, such as a web server, to facilitate product distribution and provide real time product information. Some e-commerce systems, such as the system maintained by AMP, Incorporated of Harrisburg, Pa., include a configurator. This system improves over conventional configurators by enabling real time information concerning available options and prices. The AMP system also provides limited finished product availability information by querying suppliers (distributors of a finished product and/or factories that produce a finished product) for information regarding their inventories of the finished product.

However, the finished product inventory information that is made available to the user does not reflect suppliers' abilities to produce a requested product from existing component inventories. Therefore, where suppliers utilize a just-in-time production system, whereby finished products are only produced in response to orders, and therefore maintain very little finished product inventory, the finished product inventory information is not useful in determining the capability of a given supplier to supply a desired product.

### SUMMARY OF THE DISCLOSURE

Embodiments of the invention provide a system and related processes and products that improve over the conventional configurators described above, in that the system is based on sets of rules that relate options, product components, and the product numbers that represent those products. These rules allow the system to dynamically generate a product number from user input specifying desired options, and to dynamically generate product specifications from a product number, thus eliminating the need to maintain a static database containing a record for every possible combination of options or every possible product number. This system is easily maintained compared to the conventional database implementation of a configurator, since, for example, adding or eliminating an option may be accomplished by changing a small number of rules relating to that option rather than a large number of database records affected by that option. A rules based system in accordance with embodiments of the invention further provides the capability of generating a product number and product specifications for any viable combination of options or components, irrespective of whether that combination has been produced before. Thus, systems in accordance with embodiments of the invention enable customers to dynamically configure and purchase any product having any viable combination of options or components without the need for the manufacturer or distributor to preestablish a product number or specifications for that product.

Further embodiments of the present invention provide a system and related processes and products that improve over the stand alone configurator and e-commerce systems described above, in that when a customer configures a desired product, suppliers may be queried to determine their inventories of parts necessary to produce the product, and from this information the availability of the product from each supplier may be determined. The system preferably includes a rules-based configurator that dynamically generates a parts list in response to user input specifying a product number. Further embodiments provide a rules based configurator and related processes and products.

In one embodiment, a system for determining availability of a configurable product preferably includes a processor and stored programming code providing a presentation layer that provides communication with a client through the Internet, a configurator for generating a parts list corresponding to a product number provided by the client, a data access layer for obtaining parts inventory data for parts included in the parts list from supplier parts databases, and an availability manager for determining product availability information for each of the suppliers using the parts list and the supplier's inventory data. A system in accordance with this embodiment may be accessible to customers through the Internet, and provide customers with availability information for a configurable product from multiple suppliers. The customer may specify the product number or the product's attributes.

In a related embodiment, a process in a system for determining availability of a configurable product preferably includes receiving a product number from a client through the Internet, generating a parts list corresponding to the product number, obtaining parts inventory data for the parts included in the parts list from supplier parts databases, determining product availability information for each of the suppliers using the parts list and the supplier's inventory data, and providing the availability information for each of the suppliers to the client through the Internet. A process in accordance with this embodiment allows a customer to obtain accurate availability information for a configurable product from multiple suppliers through a centralized source via the Internet by providing a product number. The customer may specify the product number or the product's attributes.

In another embodiment, a rules based configurator preferably comprises a part number database associating parts data with logical functions of field values, a processor, and stored programming instructions providing system components including a parsing engine generating product field values from a product number and a parts list engine applying the product field values to logical functions stored in the part number database to yield a parts list corresponding to the product number. In a related embodiment, a method for generating a parts list for a product preferably comprises generating product field values from a product number, applying the product field values to logical functions of field values stored in a part number database in association with parts data, retrieving parts data associated with each logical function for which application of the product field values produces a true result, and generating a parts list from the retrieved parts data.

In another embodiment, a rules based configurator preferably comprises a part number database associating parts data with part selectors, a selector database associating part selectors of the part number database with logical functions of field values, a processor, and stored programming instructions providing a parsing engine generating product field values from a product number, a selector engine applying the product field values to logical functions stored in the selector database to determine part selectors corresponding to the product number, and a parts list engine retrieving parts data corresponding to determined part selectors to generate a parts list corresponding to the product number. In a related embodiment, a method for generating a parts list for a product preferably comprises generating product field values from a product number, applying the product field values to logical functions of field values associated with part selectors to determine part selectors corresponding to the product number, retrieving parts data corresponding to determined part selectors to generate a parts list corresponding to the product number.

In a further embodiment, a system for assisting a user to select options for a configurable product comprises at least one processor to execute programming instructions, and a storage device coupled to the processor and having stored therein programming instructions to be executed by the processor. The system receives a set of selected options selected by a user of the system. The system then determines available options in view of the selected options. The available options consist of options that are not directly excluded by the selected options and that are not commonly excluded by options remaining in view of the directly excluded options. The system then generates a user interface representing the available options.

In another embodiment, a maintenance process generates exclusion rules for use in a system for configuring a product. The system generates a set of arbitrary product numbers, then discards invalid product numbers and product numbers requiring unavailable components. The system then obtains a set of components and options associated with each remaining product number. The system then creates exclusion rules indicating, for each given option present in any set associated with any product number, each option and component not present in any set associated with any product number in conjunction with said given option, and for each given component present in any set associated with any product number, each option and component not present in any set associated with any product number in conjunction with said given component. This process is preferably run after each change in component or option databases of a configurator so that products that may be configured by the system reflect the options and components available to the configurator.

In a further embodiment, a user interface for a system for configuring a configurable product is provided. The user interface presents a set of product attributes for which a user may specify options. The user interface further presents a set of available options corresponding to a selected attribute. The set of available options consists of options associated with the selected attribute that are not directly excluded by selected options associated with other product attributes and that are not commonly excluded in view of previously selected options associated with other product attributes.

A variety of other features and embodiments will be apparent from the following detailed description of preferred embodiments.

### DESCRIPTION OF THE DRAWINGS

FIG. 1 is a diagram illustrating relationships among options, product components and product numbers in accordance with embodiments of the invention;

FIG. 2 is a block diagram illustrating a system architecture in accordance with an embodiment of the invention;

FIG. 3 is a flow chart illustrating a process of operating the system of FIG. 2;

FIG. 4 is a schematic block diagram illustrating the structure of a configuration wizard in accordance with a preferred embodiment of the invention;

FIG. 5 is a flow chart illustrating an exclusion process performed in an exclusion engine, and related pseudocode, in accordance with a preferred embodiment of the invention;

FIG. 6 shows pseudocode for producing a product number from a set of selected options in accordance with a preferred embodiment of the invention;

FIG. 7 shows an exemplary layout of a user interface in accordance with a preferred embodiment of the invention;

FIG. 8 is a block diagram illustrating a rules based configurator in accordance with an embodiment of the invention;

FIG. 9 illustrates a field value database and a process and related pseudocode for parsing a product number using the field value database in accordance with an embodiment of the invention;

FIG. 10 is a block diagram of an alternative rules based configurator in accordance with an embodiment of the invention;

FIG. 11 is a block diagram of a further alternative rules based configurator in accordance with an embodiment of the invention;

FIG. 12 is a flow chart illustrating a process in a selector engine of the embodiment illustrated in FIG. 10;

FIG. 13 is a block diagram illustrating an exclusion rule generation process performed in an exclusion rule generator, and related pseudocode, in accordance with a preferred embodiment of the invention;

FIG. 14 is a block diagram illustrating a process by which an availability engine produces product availability information in accordance with an embodiment of the invention; and

FIG. 15 is a block diagram illustrating a system architecture in accordance with a further embodiment of the invention.

### DETAILED DESCRIPTION OF PREFERRED EMBODIMENTS

In preferred embodiments of the invention, it is assumed that a system for providing availability information for configurable product is operated by a manufacturer of parts that are supplied to distributors who assemble finished products, and that the manufacturer also assembles finished products at its own factories. As a result, the distributors and the factories are collectively treated herein as “suppliers” of finished products. It is also assumed that the factories and distributors generally assemble finished products in response to orders, and maintain very little finished product inventory. However, alternative embodiments may be applied to alternative distribution systems. For example, the system may be operated by a parts manufacturer that does not supply finished products. Alternatively, the system may be operated by a third party that is not involved in either manufacturing parts or supplying finished products. The system may also involve suppliers who both maintain an inventory of finished parts and assemble parts in response to orders.

In accordance with embodiments of the invention, a customer is enabled to configure a product by selecting desired options for the product or by providing a product number. Systems in accordance with embodiments of the invention utilize the relationships among the product number, the options embodied in the product, and the components from which the product is assembled to guide the user in selecting valid combinations of options and to generate a component list and specifications based on the selected options or the user-supplied product number.

Products, in accordance with embodiments of the invention, are members of product groups. The products of a product group share a common set of attributes. Each attribute has a set of options associated therewith, and a product within the product group may embody one of the options for each of attribute of the product group. The products of a product group also share a common set of component types from which they are assembled. Each component type has a set of components associated therewith, and a product within the product group may employ components from each component type of the product group. The products of a product group also share a common product number format consisting of an ordered set of product number fields. Each field has a set of values associated therewith, and a product within the product group has a product number that consists of an ordered set of field values selected from the values associated with each field.

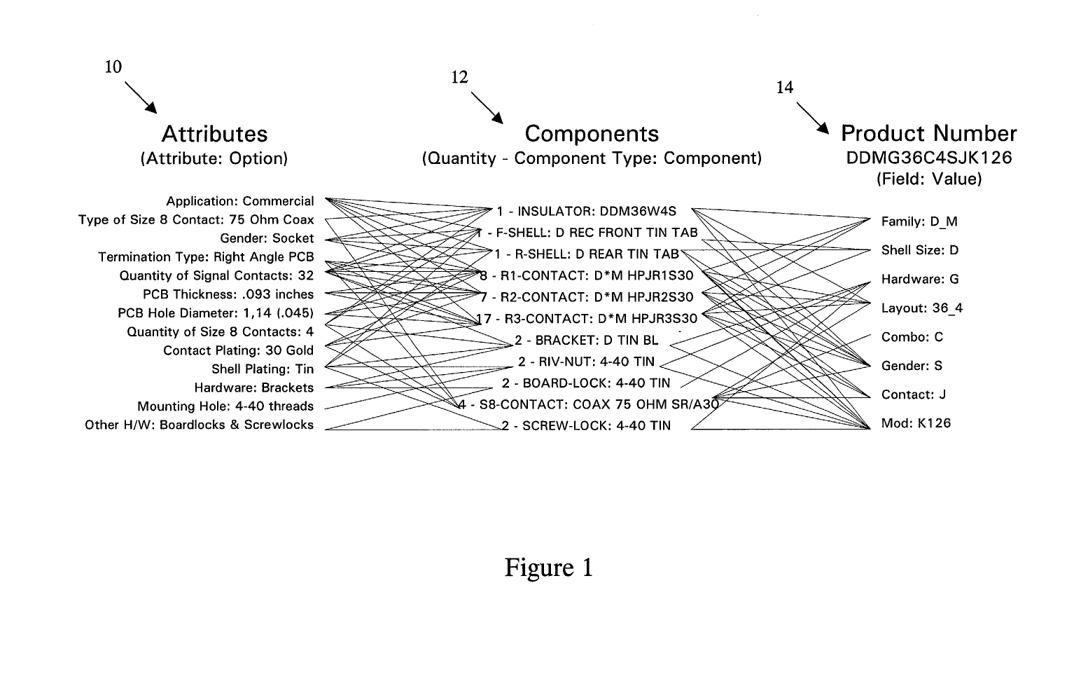

FIG. 1 illustrates relationships among attributes, component types and product number fields for an exemplary electrical connector in accordance with embodiments of the invention. The left-hand “Attributes” column 10 of FIG. 1 lists exemplary attributes of products within the product group of the connector and the options for each of those attributes that are embodied in the connector. For example, with regard to the attribute “Application,” the connector provides the option “Commercial.” An example of another option for the Application attribute is “Military”. In other words, connectors within this product group may be either Commercial or Military. Options within an attribute are mutually exclusive, meaning that only one option can be selected for an attribute.

The center “Components” column 12 lists component types for products within the product group of the connector and the particular components from which the connector is assembled. For example, the connector includes a component of the type “Insulator.” The particular Insulator is component “DDM36W4S.” It is noted that a connector within a product group does not have to include a component from every component type of that product group. Like options, components within a given component type are mutually exclusive.

The right-hand “Product Number” column 14 lists exemplary fields within the product numbers of products within the product group of the connector and the values associated with each field in the product number of the connector. The connector product number in this example is DDMG36C4SJK126. As seen in the Product Number column, the value of the second field, identified by the name “Shell Size,” is “D”. Other fields, such as the “Family” field, the “Layout” field, and the “Mod” field, have multicharacter values. In the case of the “Family” and “Layout” fields, the characters that comprise the values of those fields are not all adjacently located within the product number. Like options and components, field values within a given field are mutually exclusive.

The lines extending between the elements in each column of FIG. 1 represent the complex relationships that may exist between the options, components, and field values of a given product. FIG. 1 shows that the value of a field in the product number may be related to several of the components that make up the connector. For example, in the connector of FIG. 1, the value of the product number field “Hardware” is related to the presence in the connector of two “BRACKET: D TIN BL” components, two “RIV-NUT: 4-40 TIN” components, two “BOARD LOCK: 4-40 TIN” components, and two “SCREW-LOCK: 4-40 TIN” components. Similarly, a single component in the connector may be related to several field values in the product number. For example, the use of the “RIV-NUT: 4-40 TIN” component in the product is related to the presence in the product number of the “Hardware” field value “G” and the “Mod” field value “K126.” As discussed in detail below, embodiments in accordance with the invention employ a body of rules relating components and product number field values within a product group, such that, given the universe of components within a product group, the rules may be used to determine the unique product number representing any viable combination of those components, or the combination of components corresponding to any valid product number.

Similar relationships exist between components and options. One component may be related to several options. For example, the presence in the connector of two components “SCREW-LOCK: 4-40 TIN” is related to the option “Tin” of the attribute “Shell Plating,” and is also related to the option “Boardlocks & Screwlocks” of the attribute “Other H/W.” Similarly, one option may be related to several components. For example, the option “Boardlocks & Screwlocks” for the attribute “Other H/W” is related to the two “BOARD-LOCK: 4-40 TIN” components and to the two “SCREW-LOCK: 4-40 TIN” components listed the components column. As discussed in detail below, embodiments in accordance with the invention employ a body of rules relating components and options, such that, given a universe of components and options for a product group, the rules may be used to determine the combination of components that provides a specified set of options, or the set of options provided by any viable combination of components.

Although not illustrated in FIG. 1, relationships also exist between options and product number field values. As discussed in detail below, embodiments in accordance with the invention employ a body of rules relating options and field values, such that, given a set of attributes and the available options for each attribute, the rules may be used to determine a unique product number associated with any viable combination of those options, or the particular set of options associated with any valid product number.

System Architecture

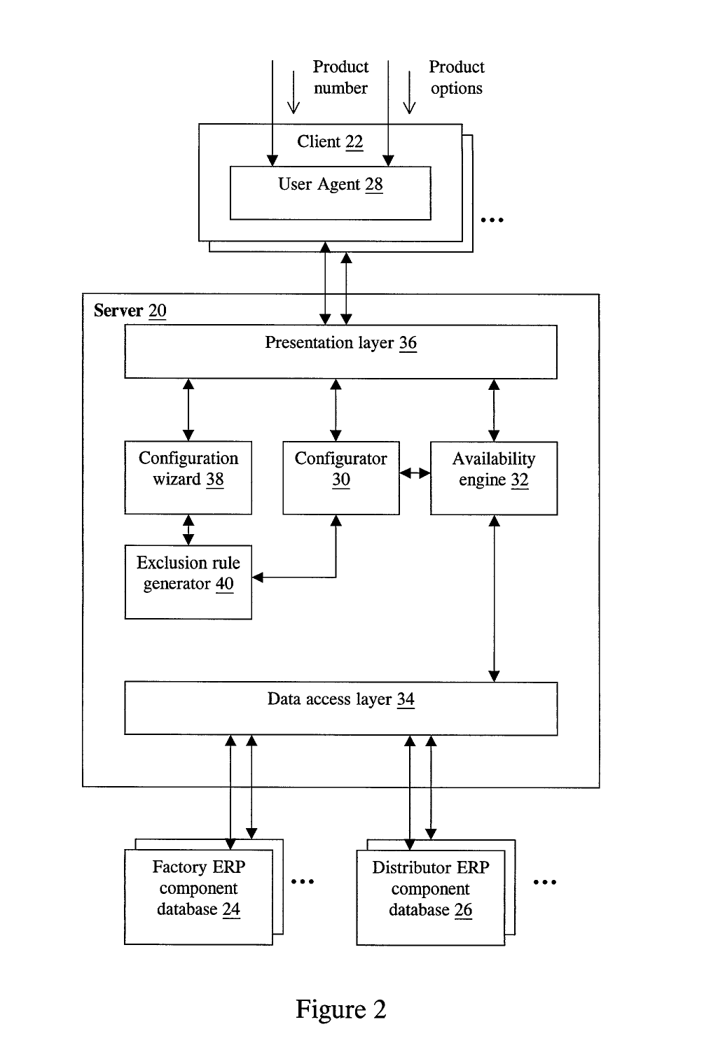

A basic architecture of a system in accordance with an embodiment of the invention is illustrated in FIG. 2. The architecture of FIG. 2 provides product specifications and product availability information for a configurable product in accordance with a product number generated by a user agent at a client operated by a customer. As shown in FIG. 2, the server 20 communicates with clients 22, and with networked factory 24 and distributor 26 enterprise resource planning system (ERP) parts databases. Each Each client 22 includes a user agent 28, such as a web browser, that resides on a customer computer system, and the server 20 preferably communicates with the clients through the Internet. Communication with the clients is preferably implemented through a presentation layer application 36 such as a java servlet or java server pages. Communication with the manufacturer 24 and distributor 26 databases is conducted through the Internet or through private networks, direct connections or other suitable links, and is preferably enabled through a data access layer application 34 that uses a standard such as XML or java database connectivity (JDBC), or a proprietary mechanism where necessary, to issue queries directly to the parts databases and to receive query results.

The server 20 further includes a configurator 30 and an availability engine 32, both of which are applications that are preferably as java applications. The configurator 30 generates product specification data including component and option lists by performing logical operations on the product number received from the client. The component and option lists are preferably provided as XML documents. The availability engine 32 uses the component list to provide component data to the data access 34 layer for use in queries to suppliers, and determines product availability using quantity data from the component list and component inventory data obtained from the supplier databases.

The server further includes a configuration wizard 38. The configuration wizard 38 cooperates with user agents in client systems to generate a product number from options for product attributes selected by a user and to determine product options that remain available for further selection in view of the options already selected. Associated with the configuration wizard is an exclusion rule generator 40 that generates exclusion rules used by the configuration wizard 38 to determine a product number and remaining options from a set of selected options.

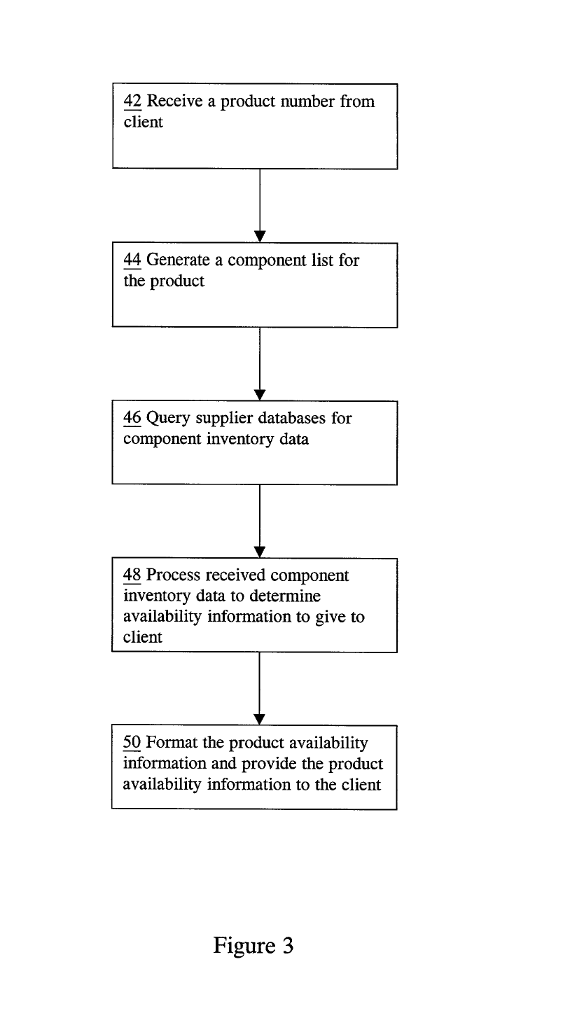

FIG. 3 presents a flow diagram of a process performed in the system illustrated in FIG. 2 to provide product availability information to a client upon receipt of a product number. Initially, the server receives 42 a product number from a client. The product number is provided to the configurator, where a component list corresponding to the product number is generated 44. Upon receiving a request from the client for product availability information, the databases of supplier (factory and/or distributor) ERP systems are queried 46 by the data access layer for inventory data. The queries request inventory data for each component in the component list. Received component inventory data is processed 48 by the availability engine and the availability information that will be provided to the client is determined. The availability information is then formatted and provided 50 to the client by the presentation layer. Implementations of each of the aforementioned tasks in accordance with preferred embodiments of the invention are described in further detail below.

Client System

In accordance with an embodiment of the invention, the client system 22 is implemented on customer data terminal equipment, such as a personal computer or workstation, that includes a network interface device and appropriate programming instructions for providing Internet access. The client system 22 further includes a display device and a user agent 28, such as a web browser, for rendering a graphical user interface on the display device that is generated by and transmitted from the server 20. The user agent 28 preferably includes a java applet enabling interaction with the server configuration wizard.

From the perspective of a customer, the graphical user interface enables direct entry of a product number, or entry of options for product attributes from which a product number is then generated. The graphical user interface preferably enables some options to be specified by presenting lists of options for each attribute from which the customer may choose. For example, in a system for configuring connectors, a customer may be enabled to choose options for such attributes as gender (e.g. plug or receptacle) and termination (e.g. cable or circuit board, straight or right angle). The graphical user interface also preferably enables the customer to specify numerical options for some attributes by entering the value of the option directly. For example, in a system for configuring connectors, a customer may be enabled to enter values indicating a number of signal lines and a number of coaxial lines. When a complete set of options has been specified, the graphical user interface displays the corresponding product number and related information such as product specifications on the user's display device, and enables the user to request availability information.

Configuration Wizard

The configuration wizard 38 of the server 20 interacts with the user agent 28 in the client system 22 to guide the user in the selection of product options, and generates a product number based on the selected options when a complete set of options has been selected. The wizard 38 applies exclusion rules to the set of selected options to determine options that remain available in view of options already selected, and provides the resulting information to the presentation layer 36 where an appropriately updated user interface is generated and provided to the user. This task is performed each time a set of selected options is received. As a result, upon each change in the selected options, a new set of available options is determined and communicated to the presentation layer 36 for updating the user interface.

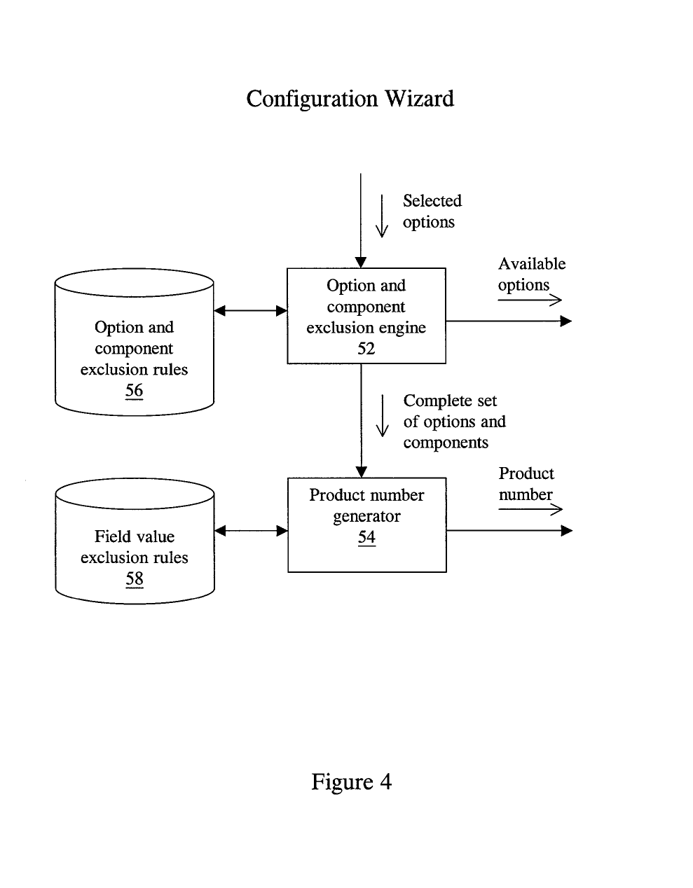

FIG. 4 illustrates the structure of a configuration wizard in accordance with an embodiment of the invention. The configuration wizard includes an option and component exclusion engine 52 and a product number generator 54. Associated with the exclusion engine 52 is an option and component exclusion rules database 56, and associated with the product number generator is a product number exclusion rules database 58.

The exclusion rules of the option and component exclusion rules database 56 include rules of the form (attribute/option):(attribute/option), which indicate that the selection of an option for a given attribute excludes the availability of the associated option for the associated attribute. Since options within an attribute are implicitly mutually exclusive, the options within a rule will typically relate to different attributes. The exclusion rules also preferably include rules of the form (attribute/option):(component_type/component) and (component_type/component):(component_type/component), indicating respectively that selection of an option excludes a product containing a given component, and that the presence of a given component excludes the presence of another component. It may further be desirable to define additional options that represent an AND combination of two options, so that given options or components are only excluded by the coexistence of two options. All of the above rules are reversible, meaning that each variable in the rule excludes the other variable. Thus a rule indicating that an option excludes a component likewise indicates that that component excludes that option. Where appropriate, distinct rule sets are preferably provided for distinct product groups. The generation of exclusion rules is discussed in further detail below.

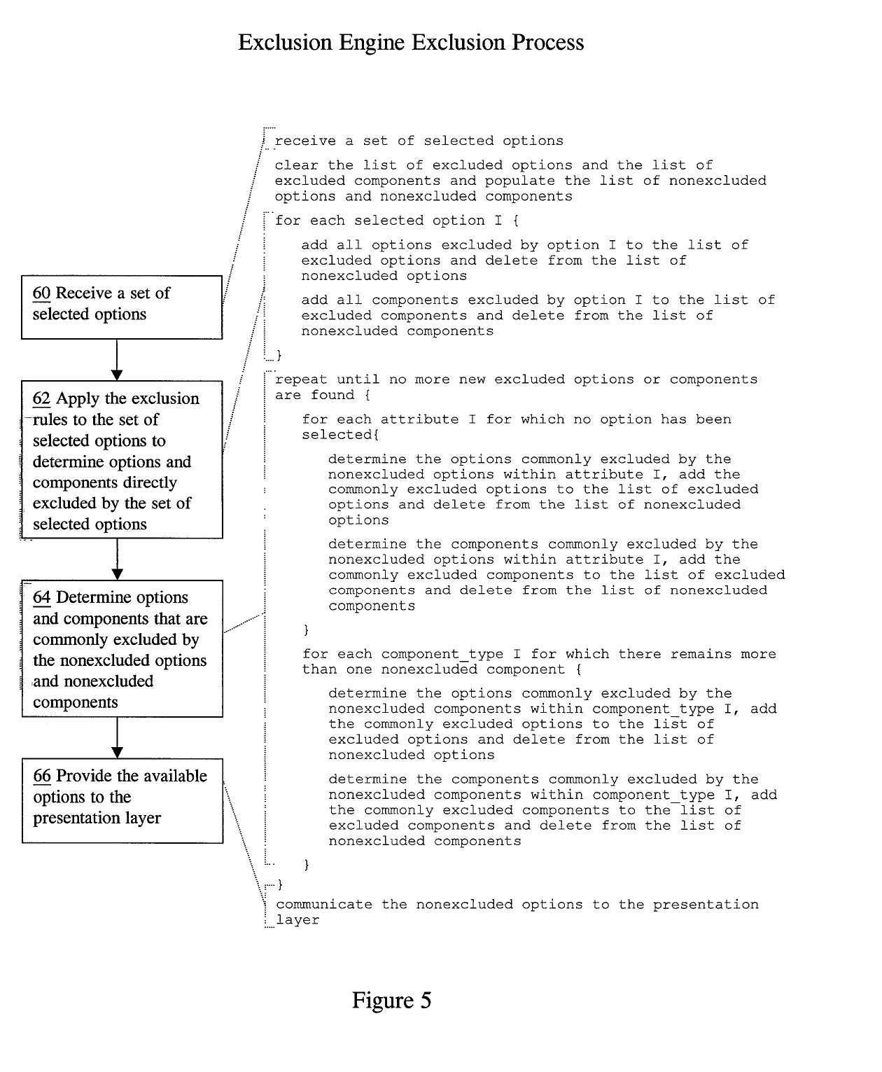

The option and component exclusion rules are used by the option and component exclusion engine 52 to determine product options that remain available in view of options that have already been selected by the user. A process performed in the exclusion engine and related pseudocode in accordance with a preferred embodiment of the invention is illustrated in FIG. 5. The process of FIG. 5 comprises four main tasks. The first task is receiving 60 a set of selected options. The second task is applying 62 the exclusion rules to the set of selected options to determine those options and components that are directly excluded by the set of selected options. This task operates on the set of attributes for which an option has been selected.

The third task is determining 64 options and components that are commonly excluded by the nonexcluded options and nonexcluded components, also referred to herein as common exclusion processing. A commonly excluded option is one that is not directly excluded by the selected options, but is still effectively excluded because selection of any of the remaining nonexcluded options within a given attribute will result in its exclusion, or because all of the remaining nonexcluded components of a given component type require its exclusion. Similarly, a commonly excluded component is a component that is not directly excluded by the selected options, but is still effectively excluded because selection of any of the remaining nonexcluded options within a given attribute will result in its exclusion, or because all of the remaining nonexcluded components of a given component type require its exclusion. Since these options and components will be excluded no matter which of the remaining nonexcluded options is selected, the determination of commonly excluded options and components system performance by removing the commonly excluded options from the list of available options that will be presented to the user, thus preventing the user from selecting an option that is not actually available. This task is performed on the attributes for which no option or component has yet been selected, and the component types for which the possible components has not been reduced to a single component. The task of determining commonly excluded options and components is performed iteratively since the elimination of a commonly excluded option or component will effectively result in another option or component being commonly excluded if the commonly excluded option or component is the only one that does not exclude another given option or component. Therefore the exclusion of commonly excluded options and components is repeated until no new common exclusions are found.

The fourth task of the exclusion process is providing 66 the available options to the presentation layer, where a new user interface is generated that presents the available options to the user. It may be preferable also to provide the set of selected options and the set of excluded options to the presentation layer.

Common exclusion processing may be performed using only exclusion rules involving options and therefore does not require the use of exclusion rules involving components. However, the use of exclusion rules involving components is preferred because it augments the intelligence of the exclusion engine by allowing the exclusion engine to identify options that are commonly excluded as a result of the limited ranges of product components that can be used in view of options already selected by the user. In either case, it is preferable to preprocess the exclusion rules prior to exclusion processing to the forms (attribute/option):(all excluded attribute/options and component_type/components) and (component_type/component):(all excluded attribute/options and component_type/components) to enhance processing speed.

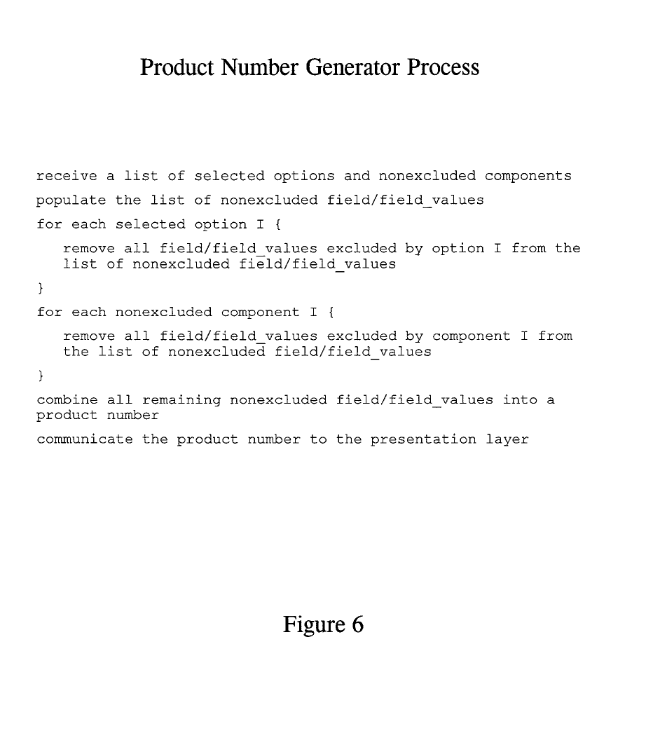

The product number generator 54 of the configuration wizard uses field value exclusion rules to determine a value for each field of a product number based on selected options. Field value exclusion rules include rules of the form (attribute/option):(field/field_value). Field value exclusion rules preferably include further rules of the form (component_type/component):(field/field_value). Where appropriate, distinct rule sets are preferably formulated for distinct product groups. Pseudocode for a process performed in the product number generator in accordance with embodiments of the invention is illustrated in FIG. 6. The input to the product number generator is the complete set of options selected by the user and the corresponding set of nonexcluded components. The product number generation process simply involves excluding field values based on the set of selected options and nonexcluded components, and then combining the nonexcluded field values in the appropriate order. In a manner similar to the option exclusion rules, it is preferable to preprocess the product number exclusion rules to the form (attribute/option):(all excluded field/field_values) and (component type/component):(all excluded field/field values) to enhance processing speed.

The exclusion logic applied by the configuration wizard 38 preferably enables the configuration wizard to generate product numbers consistent with an existing catalog of product numbers, and also to generate new product numbers that follow the format and syntax of existing product numbers when a customer specifies attributes that are not met by products in the existing catalog but could be configured from the same body of components.

The foregoing description utilizes the conceptual distinction between options and components as a tool to facilitate understanding of the information content of exclusion rules and the information that is produced through the processes in which they are used in accordance with embodiments of the invention. However, in actual implementations, it may be unnecessary to explicitly express this distinction in the exclusion rules or the processes that use them. For example, in preferred implementations of the option exclusion engine and product number generator described above, options and components are treated equally as elements of rules that do not require distinct processing based on whether the elements represent an option or a component. In such implementations, a set of nonexcluded elements is generated, which is then translated by the configuration wizard or presentation layer to determine which of those elements are options that remain available for selection and which are components that need not be represented in the user interface.

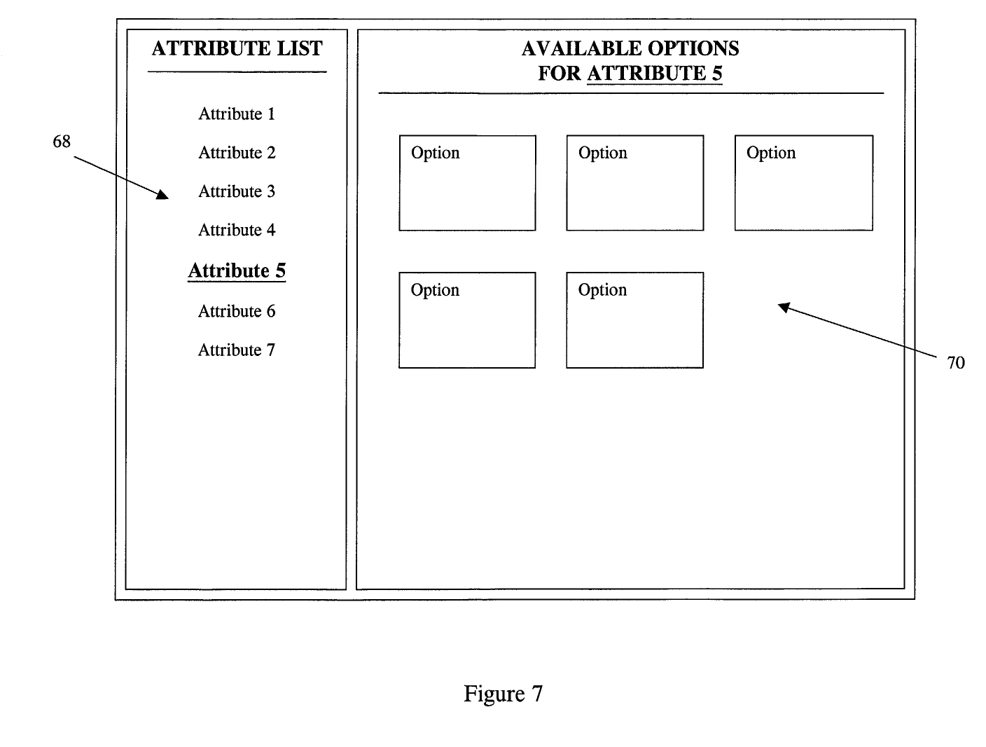

FIG. 7 illustrates an exemplary layout of a graphical user interface presented to a user through cooperation of the configuration wizard 38 and the presentation layer 36. The user interface presents a list of attributes 60 for which the user must select an option, and presents illustrations 70 of the various options that are available for a selected attribute. In the example of FIG. 7, a list of attributes 68 is provided in a column at the left-hand side of the interface, and images 70 representing options available for that attribute are provided in a larger area of the interface to the right of the attribute column. In the illustration of FIG. 7 it is shown that the user has selected Attribute 5, and therefore the options shown are those that are available to be selected for Attribute 5. The options that are shown are limited to those options that are not excluded by selected options and those options that are not commonly excluded in view of selected options. By preventing the display of commonly excluded options, the user is not enabled to select a commonly excluded option, and therefore it is not possible for the user to select an option that would subsequently be found by the configuration wizard to be unavailable and therefore result in a processing error requiring the user to select a different option.

As discussed above, the user interface is generated based on a set of selected options. Based on the selected options, the configuration wizard 38 determines corresponding excluded options and components. The manner in which this information is translated into a user interface showing available options can be implemented in a variety of ways. Typically it is preferred that the configuration wizard 38 and presentation layer 36 share access to a database that contains the attribute/option and component_type/component lists, and flags each of those attributes that are user selectable. Using this database, the configuration wizard 38 may, for purposes of common exclusion processing, determine those options and components that remain available for selection in view of direct exclusions by selected options. Either the configuration wizard 38 or the presentation layer 36 may further determine which options and components that remain available in view of direct and common exclusions, and which available options relate to selectable attributes and therefore should be displayed in the user interface.

Configurator

A product number received by the server from the client is provided to the configurator through the server presentation layer application. The configurator is preferably a rules based system that dynamically assembles component lists, option lists and other product specifications by applying logic to the field values of a product number to determine the information to be included in the product specifications.

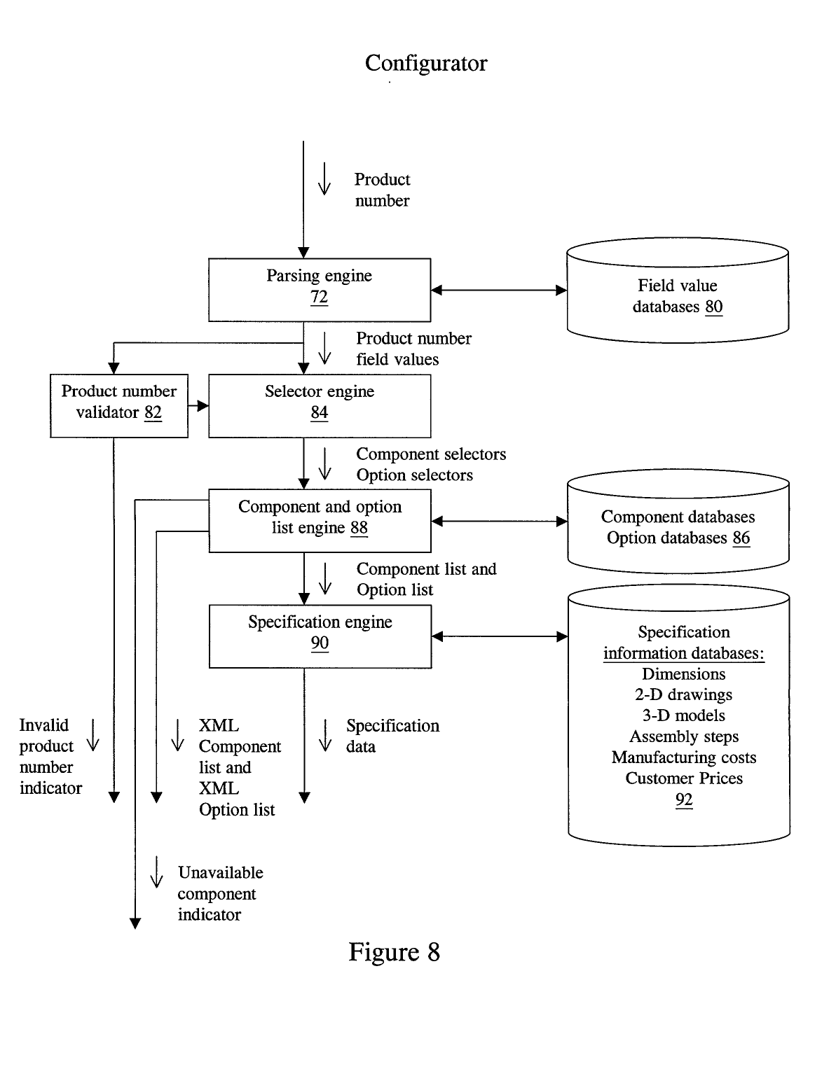

FIG. 8 illustrates a configurator in accordance with a first embodiment of the invention. In this embodiment the input to the configurator is a product number. The product number is parsed by a parsing engine 72, which assigns each character of the product number to a field of the product number structure by referencing data stored in a field value database 80. For a given product number, the value of each field may consist of no characters of the product number, one character of the product number, or more than one character of the product number.

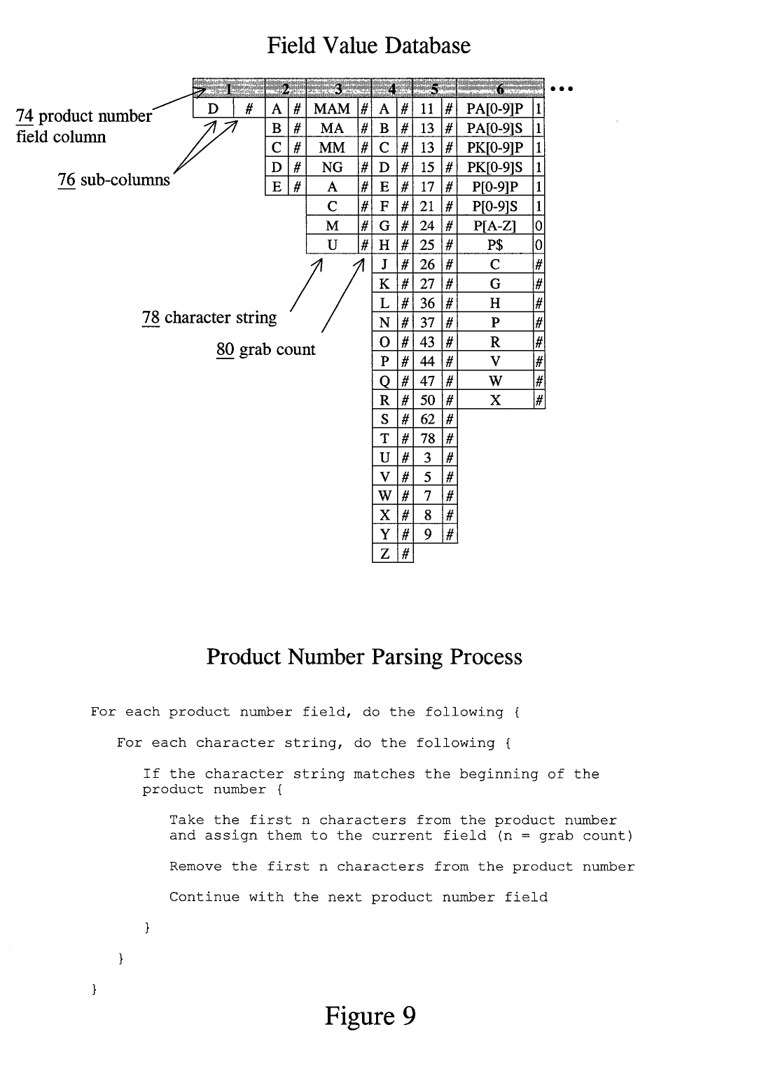

FIG. 9 illustrates a preferred embodiment of a field value database and pseudocode for a product number parsing process performed in the parsing engine using the field value database. The field value database includes a table in which each column corresponds to a field of the product number. Where there are multiple product groups having different product number field formats, it is preferred to provide individual tables for each group.

FIG. 9 shows the first six columns of a table for an exemplary product number format. Each product number field column 74 of the table comprises two sub-columns 76, the first containing character strings 78, and the second containing associated “grab counts” 80. As described in the corresponding pseudocode, the parsing engine determines a value for each product number field column 74 sequentially, beginning with the first field. For each product number field column 74, the character strings 78 in the first sub-column are sequentially compared to the beginning characters of the product number. When a character string 78 in the first sub-column matches the beginning characters of the product number, a number of characters as indicated in the second sub-column are “grabbed,” i.e. removed from the beginning of the product number and assigned as the value of the corresponding product number field 74. The value to be assigned to the next field is then determined using the remaining characters of the product number.

In the table of FIG. 9, the sub-column grab count value “#” indicates that the number of characters grabbed is equal to the number of characters in the associated character string of the first sub-column, the grab count value “1 ” indicates that one character is grabbed, and the grab count value “0” indicates that a null character (i.e. no character) is grabbed. The use of grab counts that are different than the number of characters in their associated character strings allows the parsing engine to look ahead to values beyond those of the immediate field in order to determine the appropriate field value. For example, in the sub-columns under column 6, the grab count for the three character string P[0-9]S is 1, and the grab count of the two character string P[A-Z] is 0. Accordingly, when assigning characters to the sixth field of the product number, if any value POS-P9S is found at the beginning of the product number, the first character P is assigned to the sixth field and removed from the product number. However, if any value PA-PZ is found at the beginning of the product number, a null character is assigned to the sixth field, and no character is removed from the product number. In this manner the parsing engine 72 is enabled to look forward to additional characters to determine whether a particular character belongs in the presently examined field or in a succeeding field.

Referring again to FIG. 8, the output of the parsing engine 72 is a set of values associated with the fields of the product number. The product number field values are provided to a product number validator 82, which applies validation rules to the set of field values to determine whether the product number is valid. Product number validation serves the purposes of determining the validity of product numbers manually entered by users, and of identifying invalid product numbers for purposes of exclusion rule creation as discussed below. Examples of invalid product numbers are numbers that indicate a combination of components that cannot be physically combined, or that could be physically combined but would be illogical to use in the same product.

The product number validator 82 produces an indicator when an invalid product number is detected. The indicator is provided as output for use in exclusion rule creation and may be used by the presentation layer to generate a display for notifying a user that the product number is invalid. The indicator may also be used to disable further operations of the configurator 30 on an invalid product number. In the embodiment illustrated in FIG. 8, the invalid product number indicator is provided to the selector engine 84 to disable further processing of invalid numbers. The product number field values generated by the parsing engine are also passed to the selector engine 84. The output of the selector engine 84 is a set of component selectors that are associated with component database records 86 containing individual component information, and a set of option selectors that are associated with option database records containing individual option information 86. In the selector engine 84, manufacturing rules are applied to the field values. The manufacturing rules are logical combinations of field values that are associated with component selectors of the component databases and option selectors of the option databases. In the embodiment of FIG. 8, the manufacturing rules applied to the field values are compiled and stored in the selector engine 84.

The component selectors and option selectors are passed to a component and option list engine 88. The output of the component and option list engine 88 is a component list that provides each component of the product and its quantity, and an option list that provides each option embodied in the product. The list engine 88 retrieves component and option records from component and option databases 86 using the selectors received as input and assembles component and option lists from the retrieved records. The component and option lists are provided as output to a specification engine 90, for example, through shared memory space. In addition, the component and option lists are made available as XML documents for use by other applications such as the availability engine 32. The following is an example of a XML component list document that could be generated by the parts list engine:

<PRODUCT>

<PRODUCTNUMBER>1535-345-1875</PRODUCTNUMBER>

<FAMILY>D-Sub</FAMILY>

<COMPONENTS>

<COMPONENT>

<COMPONENTNUMBER>325535-7456</COMPONENTNUMBER>

<QTY>5</QTY>

<UNIT>PCS</UNIT>

</COMPONENT>

<COMPONENT>

<COMPONENTNUMBER>412435-1349</COMPONENTNUMBER>

<QTY>3</QTY>

<UNIT>PCS</UNIT>

</COMPONENT>

<COMPONENT>

<COMPONENTNUMBER>345568-0875</COMPONENTNUMBER>

<QTY>8</QTY>

<UNIT>PCS</UNIT>

</COMPONENT>

</COMPONENTS>

</PRODUCT>

The data within this XML document includes values associated with the following predefined elements: product, product number, product family, components, component, component number, quantity, and unit.

The list engine 88 further provides an unavailable component indicator when a component associated with a received selector is indicated to be unavailable in the component database 86. A component may be unavailable if, for example, the manufacturer is temporarily unable to produce that component, or the component is being phased out altogether. Under those circumstances it is desirable for the presentation layer to use the unavailable component indicator to generate a display indicating to a user that the component is unavailable because this may affect product availability. In accordance with embodiments of the invention, the component database 86 may be altered by inserting data such as a flag that indicates to the list engine that the component is unavailable. This illustrates an advantage of embodiments of the invention over conventional product database configurators, in which the unavailability of one component requires alteration of every record for every product containing that component, rather than alteration of the single record for the affected component from which all component lists, specifications and other information for products involving that component are generated.

The specification engine 90 receives the component list and option list from the list engine 88 and applies further manufacturing rules to the component list data and option list data to determine selectors for retrieval of partial specification records from partial specification record databases 92. In preferred embodiments of the invention, multiple data bases provide records containing types of specification information that partially represent aspects of a product such as dimensional information, 2-D drawings, 3-D models, assembly steps, manufacturing costs, and customer prices. The selectors generated by the specification engine 90 are associated with various partial specification records that are relevant to a particular product. Partial specification records are preferably generic to multiple products, and the specification engine logic is preferably designed to identify all partial specification records relevant to a specific product such that the combination of records produced for the product constitutes a specification that is tailored to that product. Retrieved partial specification records are collected and provided to the presentation layer 36, where they are formatted for display by the client system.

It is preferred that the manufacturing rules applied by the selector engine 84 are determined through an iterative process. Particularly, a body of product numbers and their corresponding components and options are first provided. Beginning with any product number, a rule for translating a product number field value or a combination of field values to a corresponding component or option selector is proposed. This proposed rule is then applied to the body of product numbers to generate proposed selectors for each product. Those selectors are then compared to the actual product specifications. If any proposed selector is associated with a component or option that is not included in the product, an erroneous result has been produced and the proposed rule is invalid. The proposed rule is then modified to address the erroneous result and the modified proposed rule is applied to all existing product numbers to generate new proposed selectors. The process of modification and testing is repeated until a proposed rule produces no erroneous result. The rule is then adopted and incorporated in the selector engine. It is also preferable for the manufacturing rules applied by the specification engine 90 to be developed through an analogous process.

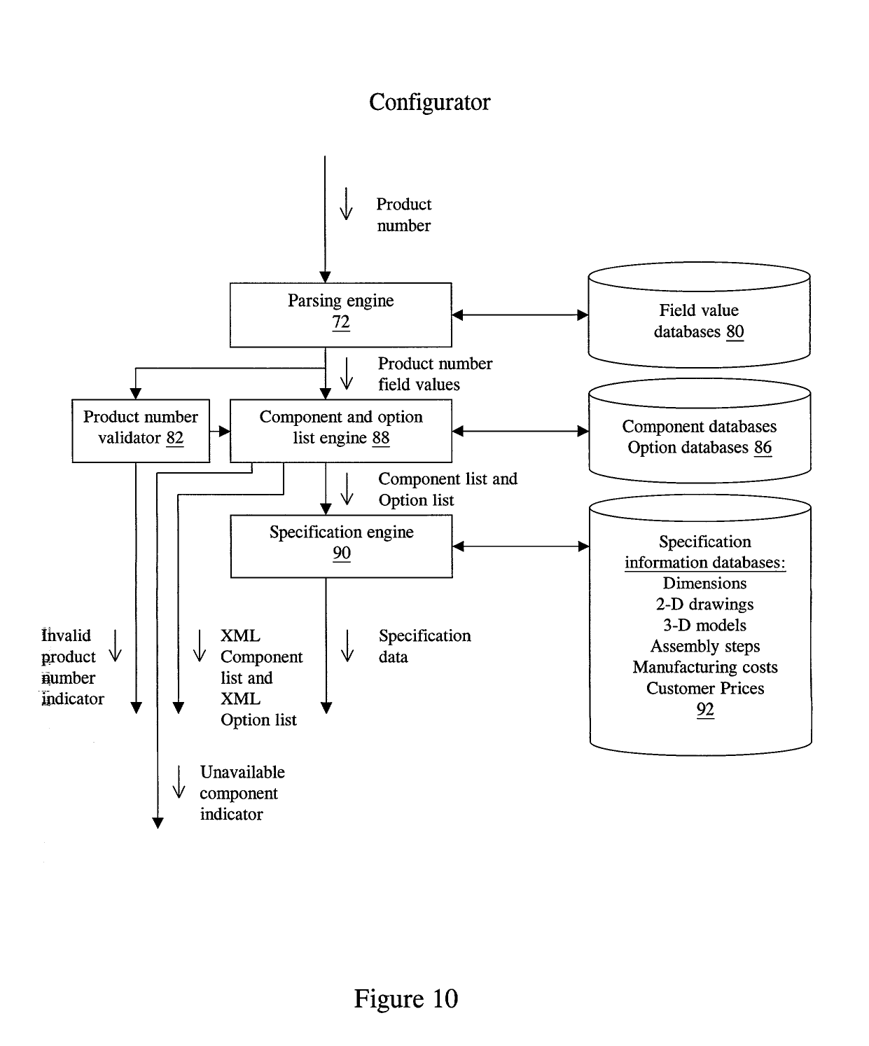

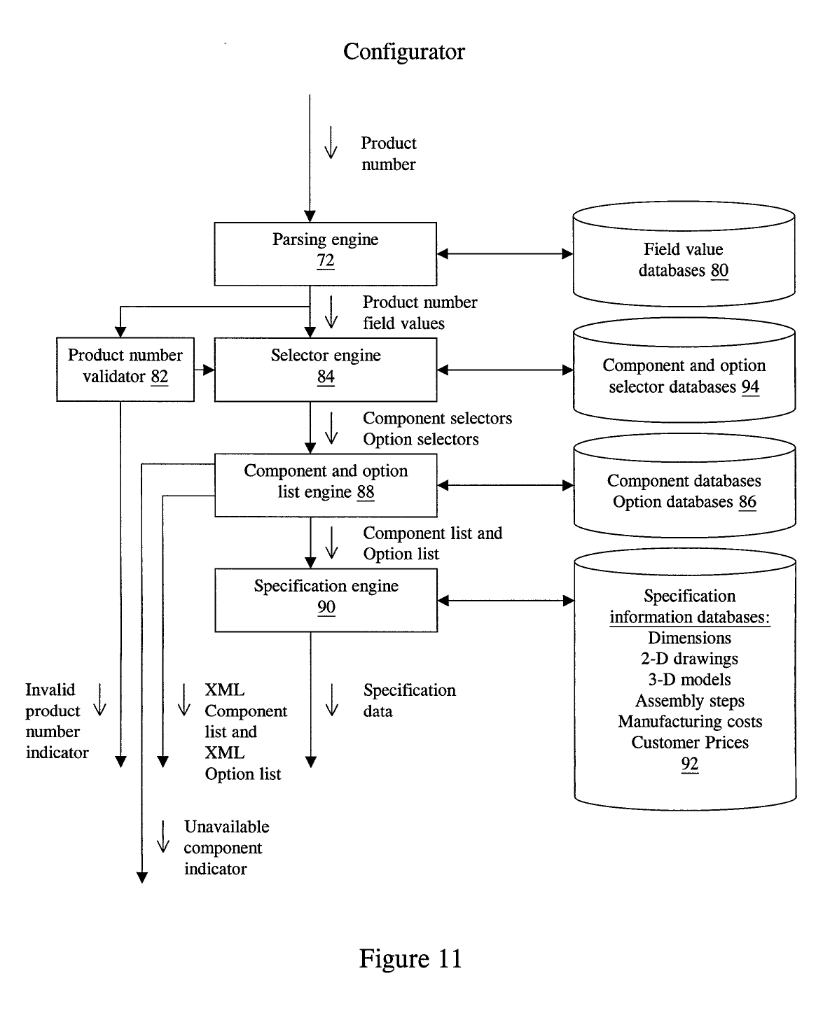

Alternative configurators in accordance with alternative embodiments are illustrated in FIGS. 10 and 11. The configurator of FIG. 10 differs from that of FIG. 8 in that the selector engine is eliminated, and the logic that was compiled in the selector engine of FIG. 8 is redistributed to the selector fields of the component and option databases 86. In other words, each component and option record is associated with a selector that takes the form of a logical function of product number field values. Accordingly, rather than applying compiled rules to field values in a selector engine to generate selectors that are then used by the list engine 88 as in FIG. 8, the list engine 88 of FIG. 10 applies the rule stored in each selector field of the component and option databases 86 to the set of product number field values, and any record for which the associated rule provides a true result is retrieved from the database.

The configurator of FIG. 11 differs from that of FIG. 8 in that the logic implemented in the selector engine 84 of FIG. 8 is redistributed to selector fields of field-specific component and option selector databases 94. In other words, each selector of the component and option databases 86 appears as a record in a component or option selector database 94, and is associated with a selector rule that takes the form of a logical function of product number field values. The selector engine 84 applies the set of product number field values to each selector rule, and for each selector rule that produces a true result, the associated selector is retrieved. Those selectors are then used by the list engine 88 to retrieve component and option records.

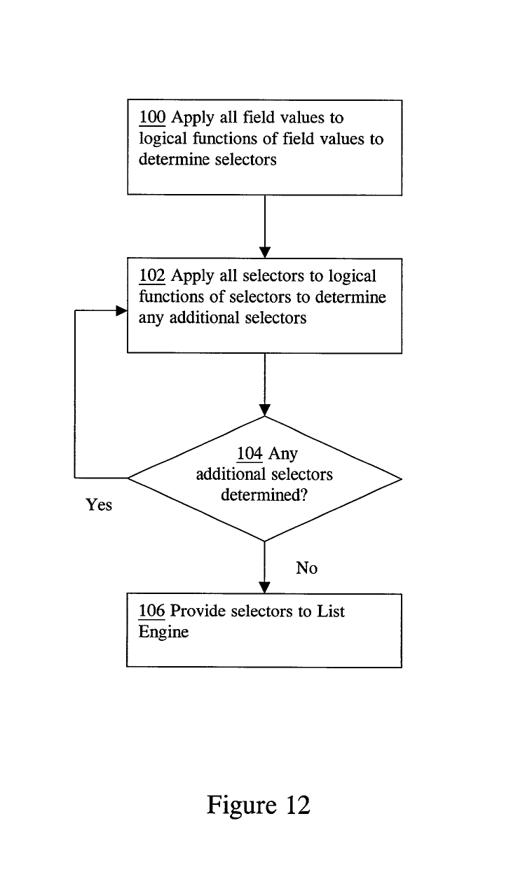

In a preferred implementation of the system of FIG. 11, each record in the selector database 94 may be associated with both a logical function of field values as described above, and a logical function of selectors. Particularly, in accordance with this preferred implementation, the selector engine 84 performs a process as shown in FIG. 12. In this process, the selector engine 84 applies 100 field values to logical functions of field values to determine selectors. Then, determined selectors are applied 102 to logical functions of selectors to determine any additional selectors. If further selectors are determined 104, all determined selectors are again applied to the logical functions of selectors. This is repeated until no new selectors are determined, and then all selectors are provided 106 to the list engine 88.

In the preferred embodiment of FIG. 11, the number selectors themselves may be comprised of multiple fields that describe different features of the corresponding parts. This embodiment is preferred over those of FIGS. 8 and 10 because it provides the least redundant and most maintainable logic and data storage.

Exclusion Rule Generator

In accordance with embodiments of the invention, an exclusion rule generator 40 associated with the configuration wizard 38 automatically generates exclusion rules for use in the exclusion engine 56 and the product number generator 58 of the configuration wizard 38. As discussed above, the option exclusion rules used in the exclusion engine 56 are of the forms (attribute/option):(attribute/option). (attribute/option): (component_type/component) and (component_type/component):(component type/component), and the field value exclusion rules used in the product number generator 58 are of the forms (attribute/option):(field/field_value) and (component_type/component):(field/field_value).

The exclusion rule generator 40 generates exclusion rules through analysis of the sets of options, components, and field values associated with each product number in a sample set of valid, arbitrarily selected product numbers. For example, to determine the exclusion rules for a given option, the sets of options, components, and field values for each product number are examined to identify all options, components, and field values that do not appear in conjunction with the given option for any product number. Exclusion rules for a given component or a given field value are determined in a similar manner. The number of exclusion rules generated by a sample set of product numbers decreases as the sample size increases, since, for example, a product demonstrating the coexistence of one option with another option, and therefore indicating that the options are not mutually exclusive, is more likely to be included in a larger sample than in a smaller sample. In practice it has been found that for any given number of potential options, components, and field values, there is sample size beyond which additional samples do not significantly alter the number of exclusion rules generated by the sample.

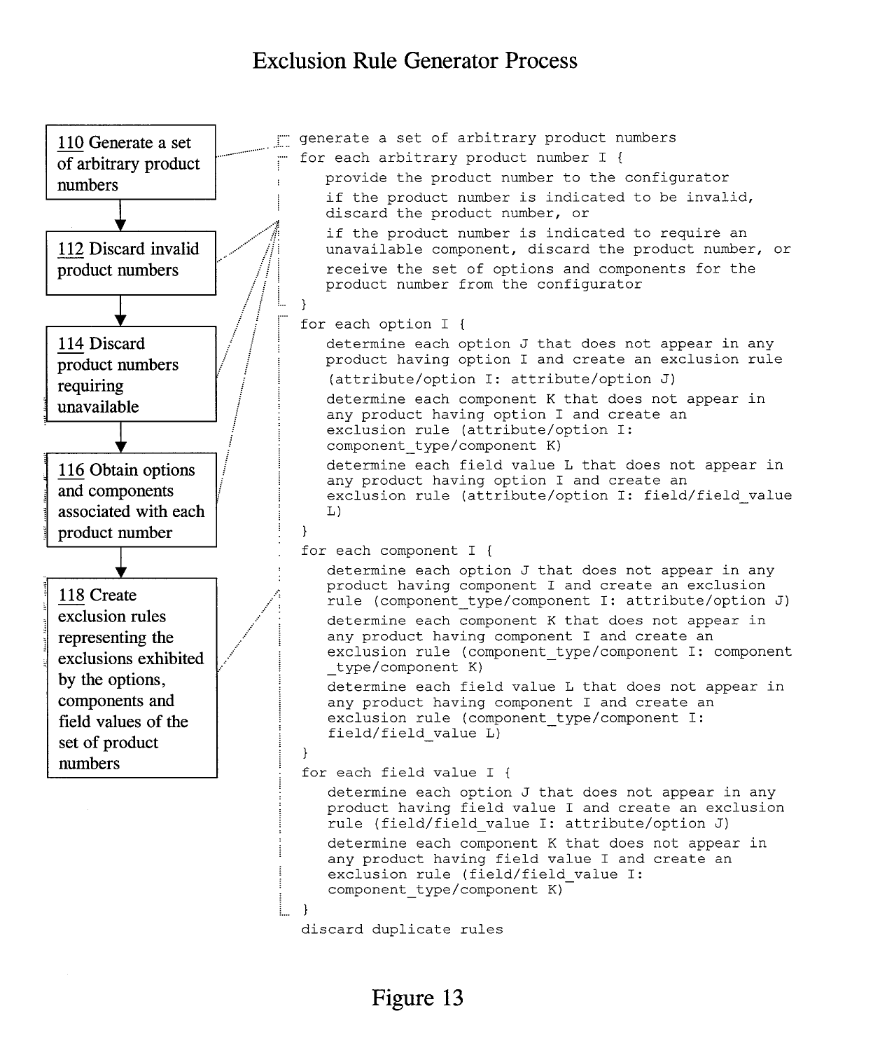

An exclusion rule generation process performed in the exclusion rule generator 40 in accordance with a preferred embodiment of the invention and related pseudocode is illustrated in FIG. 13. The process comprises five main tasks. The first task involves generating 110 a set of arbitrary product numbers. This may be performed by providing a table of every possible value for each field of a product number and randomly selecting a value for each field. Preferably the selection is not truly random, but rather is governed by conditional selection rules that limit the ranges of values that may be selected for given fields based on values already selected for other fields, in order to prevent the generation of product numbers already known to be undesirable. An example of an undesirable product number is one that provides a set of options that is provided by another product and that uses outdated components that are being phased out by the manufacturer. By preventing such product numbers from being used in the exclusion rule generation process, the resulting set of exclusion rules will result in the generation of the manufacturer's preferred product number when a user selects a set of options that would be met by either the preferred product number or the undesirable product number. Although it is preferred to exclude such duplicate numbers automatically in the number generation process, alternatively the numbers and their corresponding option sets may be scanned manually to identify and remove undesirable numbers.

The second and third tasks involve discarding 112 invalid product numbers and discarding 114 product numbers calling for unavailable components. This is done by providing each product number to the configurator 30. As discussed above, the processing performed in the configurator 30 includes identifying invalid product numbers, and identifying product numbers that call for unavailable components. Thus, if the configurator 30 returns an invalid product number indicator or an unavailable component indicator, the product number is discarded. The advantage of discarding numbers calling for an unavailable component is that the unavailable component will not appear in the sample set, and therefore will be treated as having been excluded by other components or options in the rule generation process. Consequently, the exclusion rules will prevent users of the configuration wizard from selecting option sets that call for the unavailable component. Similar advantages are obtained by discarding invalid product numbers.

The fourth task involves obtaining 116 the sets of options and components associated with each product number. As discussed above, the configurator 30 provides an option list and component list for a product number that is not invalid and does not call for an unavailable component. It is preferable that the component lists include a null component where no component of a given component type is used in the product.

The fifth task involves creating 118 exclusion rules representing the exclusions exhibited by the options, components and field values of the set of product numbers. This is done by successively isolating each option, component, and field value appearing in conjunction with any product number, and determining which other options, components, and field values do not occur in any product having the isolated option, component or field value. Each option, component, and field value that does not occur in any product having the isolated option, component or field value is treated as being excluded and a corresponding exclusion rule is created. Since this process may produce duplicate exclusion rules, duplicate rules are preferably identified and discarded.

As noted above, it is advantageous to discard product numbers calling for unavailable components because the resulting exclusion rules will prevent users of the configuration wizard 38 from selecting option sets that call for the unavailable component. Thus, in accordance with embodiments of the invention, exclusion rules are preferably regenerated every time the component and option database 86 of the configurator 30 is updated, such as by adding or deleting an option or component, in order to maintain consistency between the product configurations obtainable through use of the configuration wizard 38 and the product configurations that are possible using the options and components listed in the configurator databases 86.

Although the foregoing description utilizes the conceptual distinction between options and components as a tool to facilitate understanding of the information content of exclusion rules and the information that is produced through the processes by which they are produced, in actual implementations it may be unnecessary to explicitly express these distinctions. For example, while component elements and option elements of rules described above are described as having the form (attribute/option):(component type/component), these forms describe the information content of the rule rather than a format of the data that represents it.

Availability Engine

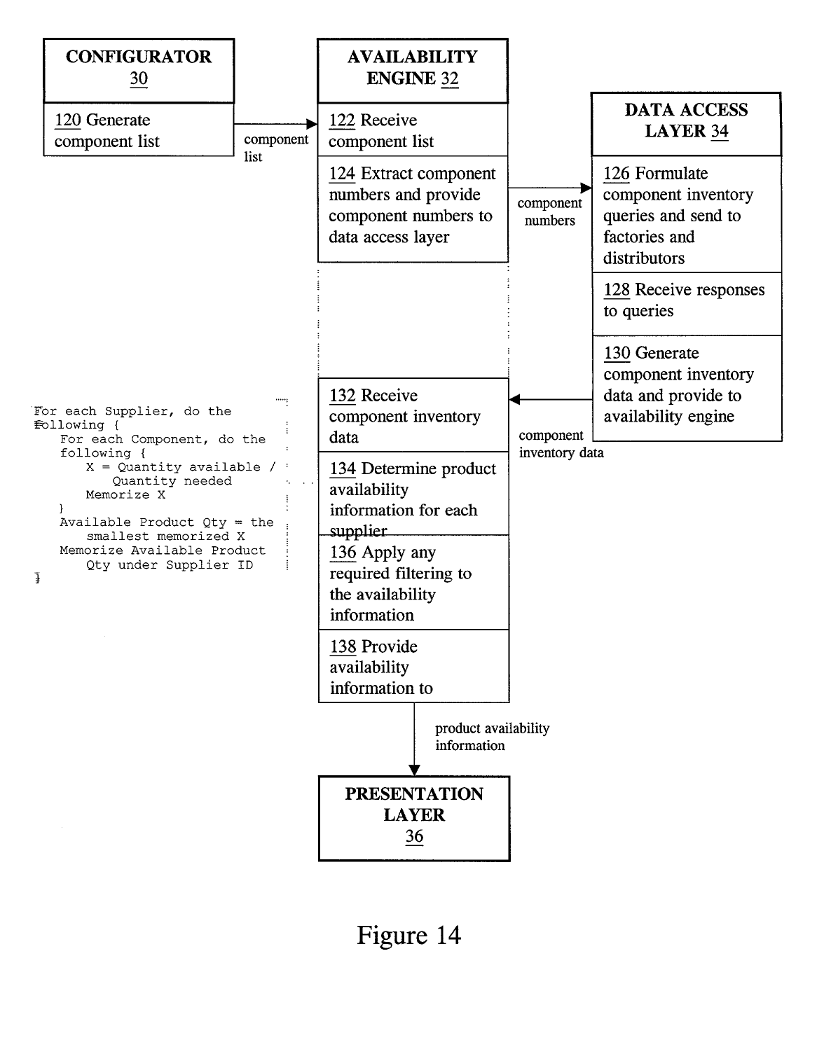

FIG. 14 shows the operation of the availability engine and its interaction with other applications in accordance with a preferred embodiment. Initially, the availability engine receives 122 a component list that has been generated by the configurator 30. An example of an XML component list is provided above in the discussion of configurators. After receiving the component list, the availability engine 32 extracts 124 component numbers or other identifiers of the individual components and provides them to the data access layer 34. Extraction of component numbers may be done using an XSL processor to filter out data in the component list that is not associated with <COMPONENTNUMBER>tags, and to generate a second XML document containing only the component number data. The following is an example of XML component number data that could be generated from the component list above:

<COMPONENTS>

<COMPONENT>

<COMPONENTNUMBER>325535-7456</COMPONENTNUMBER>

</COMPONENT>

<COMPONENT>

<COMPONENTNUMBER>412435-1349</COMPONENTNUMBER>

</COMPONENT>

<COMPONENT>

<COMPONENTNUMBER>345568-0875</COMPONENTNUMBER>

</COMPONENT>

</COMPONENTS>

The data access layer 34 processes the received XML document to formulate 126 queries to the various factory and distributor databases with which the system has connectivity, and sends the queries. The nature and format of the query provided to each supplier depends on the individual supplier's system, and it is preferred that the data access layer includes appropriate programming for generating the required queries. Typically, the queries provide component numbers and request the total number of each component in inventory. After receiving 128 responses to the queries, the data access layer 34 processes the replies to generate 130 component inventory data for each supplier, and provides the component inventory data to the availability engine 32. The component inventory data is preferably provided as an XML document. The following is an example of an XML document that could be produced by the data access layer to convey component inventory data:

<COMPONENTS>

<COMPONENT>

<COMPONENTNUMBER>325535-7456</COMPONENTNUMBER>

<QTY AVAILABLE SUPPLIER_ID=“FactoryA”>234</QTY_AVAILABLE>

<QTY_AVAILABLE SUPPLIER_ID=“FactoryB”>344</QTY_AVAILABLE>

<QTY_AVAILABLE SUPPLIER ID=“DistributorA”>14</QTY AVAILABLE>

<QTY_AVAILABLE SUPPLIER_ID=“DistributorB”>0</QTY_AVAILABLE>

</COMPONENT>

<COMPONENT>

<COMPONENTNUMBER>412435-1349</COMPONENTNUMBER>

<QTY_AVAILABLE SUPPLIER_ID=“FactoryA”>4574</QTY_AVAILABLE>

<QTY AVAILABLE SUPPLIER_ID=“FactoryB”>5477</QTY_AVAILABLE>

<QTY_AVAILABLE SUPPLIER_ID=“DistributorA”>1454</QTY_AVAILABLE>

<QTY_AVAILABLE SUPPLIER_ID=“DistributorB”>765</QTY_AVAILABLE>

</COMPONENT>

<COMPONENT>

<COMPONENTNUMBER>345568-0875</COMPONENTNUMBER>

<QTY AVAILABLE SUPPLIER ID=“FactoryA”>3567</QTY AVAILABLE>

<QTY_AVAILABLE SUPPLIER_ID=“FactoryB”>954</QTY_AVAILABLE>

<QTY AVAILABLE SUPPLIER ID=“DistributorA”>236</QTY_AVAILABLE>

<QTY AVAILABLE SUPPLIER ID=“DistributorB”>7367</QTY AVAILABLE>

</COMPONENT>

</COMPONENTS>

The data within the above XML document includes values associated with the following predefined elements: component, component number, and quantity available. The quantity available element has two attributes: supplier ID, and quantity.

The component inventory data is received 132 by the availability engine 32, and processed 134 to determine product availability information. Product availability information is broadly defined to encompass any information that indicates whether a product is available from a supplier. Such information may include, but is not limited to, a simple indication that a product can be obtained from a supplier, or a specific quantity that can be obtained from a supplier, or confirmation of whether a requested quantity can be obtained from a supplier. FIG. 14 includes pseudocode illustrating one example of processing of component inventory data to generate product availability information. In this example, the maximum number of products that each queried supplier can provide is determined by calculating the number of products for which there is component stock on a per-component basis, and selecting the lowest number. Of course, further calculation may be performed. For example, the resulting available quantities may be compared to a quantity requested by the customer to determine whether the requested quantity is available.

After product availability information is determined, the availability engine 32 applies 136 any necessary filtering to the information to limit the amount of information made available to the customer. For example, if the server is operated by a factory that makes components and distributes finished products, the factory may selectively make itself known to the user as a potential supplier of a given finished product based on factors such as order volume, order price, type of product, preferred customer status, or the customer's geographic region. Filtering may be optional, such that in some instances no filtering is applied.

After the availability information is filtered, the availability engine provides 138 the filtered availability information to the presentation layer 36. The information is preferably provided in the form of an XML document. The following is an example of an XML document that could be produced by the availability engine 32 to convey the product availability information:

<PRODUCT>

<PRODUCTNUMBER>1535-345-1875</PRODUCTNUMBER>

<FAMILY>D-Sub</FAMILY>

<QTY_AVAILABLE SUPPLIER ID=“Factory A”>46</QTY AVAILABLE>

<QTY AVAILABLE SUPPLIER ID=“Factory B”>68</QTY AVAILABLE>

<QTY_AVAILABLE SUPPLIER ID=“Distributor A”>2</QTY_AVAILABLE>

<QTY_AVAILABLE SUPPLIER_ID=“Distributor B”>0</QTY_AVAILABLE>

<COMPONENTS>

<COMPONENT>

<COMPONENTNUMBER>325535-7456</COMPONENTNUMBER>

<QTY>5</QTY>

<UNIT>PCS</UNIT>

</COMPONENT>

<COMPONENT>

<COMPONENTNUMBER>412435-1349</COMPONENTNUMBER>

<QTY>3</QTY>

<UNIT>PCS</UNIT>

</COMPONENT>

<COMPONENT>

<COMPONENTNUMBER>345568-0875</COMPONENTNUMBER>

<QTY>8</QTY>

<UNIT>PCS</UNIT>

</COMPONENT>

</COMPONENTS>

</PRODUCT>

The data in the above XML document identifies the product number, its individual components and their quantities, and the quantity of product available from each of the identified suppliers. The XML document is processed in the presentation layer where it is formatted for display by the client user agent.

In an alternative embodiment, the availability engine 32 may be augmented to query suppliers for information using both component list data and product numbers. In this manner, the resulting product availability information will reflect any finished product inventory that the supplier may have on hand.

Transaction Management

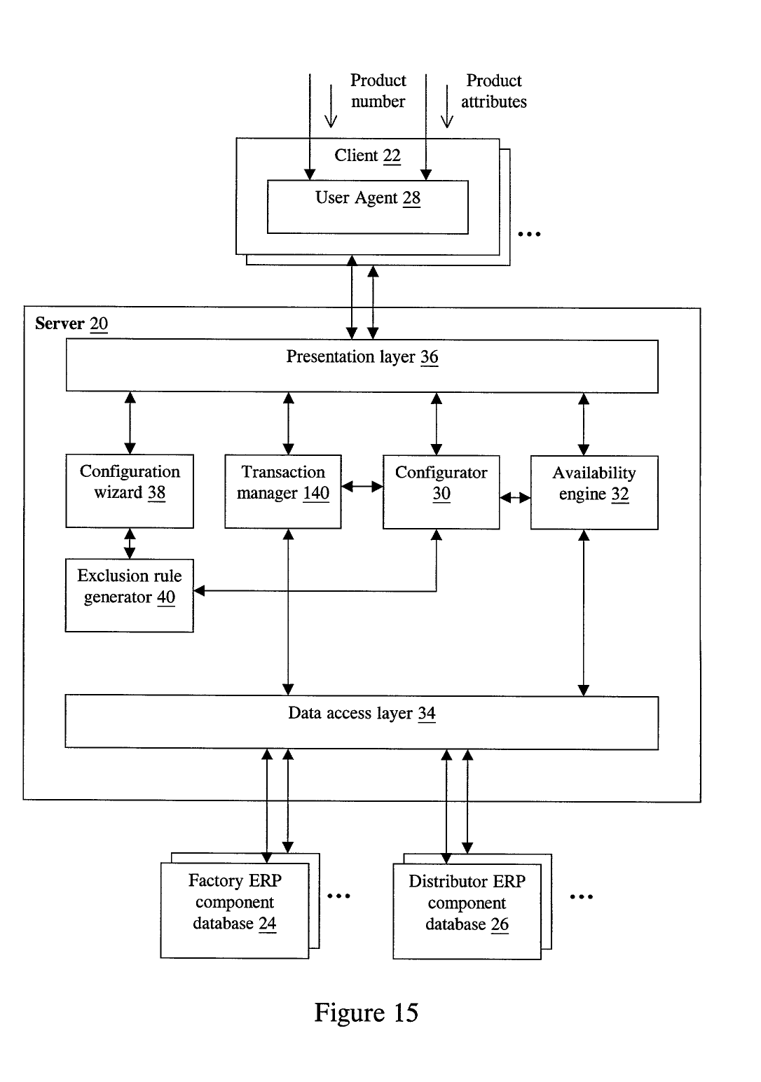

FIG. 15 illustrates a further embodiment of the invention, in which the system provides e-commerce services such as initiating transactions with the manufacturer and distributors. As shown in FIG. 15, this system adds a transaction manager 140 to the system of FIG. 1. A transaction request is generated by the client user agent 28 and is provided to the transaction manager 140 through the presentation layer 36. The transaction request may include information such as a product number and quantity, a customer identifier, supplier identifier, and terms of delivery. The transaction request is preferably provided in the form of an XML document. In practice, the transaction request process may be automated through a user interface that makes available a transaction screen upon determination or receipt of a product number. The transaction request is processed by the transaction manager 140 and forwarded to a factory order system or distributor order system as appropriate. The transaction request generated by the transaction manager 140 may include additional product information such as a component list and assembly process specifications to enable the assembly of the finished connector. Upon receiving and processing the transaction request, the distributor or manufacturer returns a transaction confirmation to the transaction manager that is forwarded to the customer. Additionally, transaction manager may provide order tracking and delivery status.

It will be appreciated by those of ordinary skill in the art that the client and servers described above may be implemented on computing devices controlled by appropriate programming instructions. Accordingly, embodiments of the invention may comprise a computing device including a processor to execute programming instructions and a storage device coupled to the processor and containing programming instructions for providing the components of the client or server. Appropriate storage devices may include but are not limited to volatile memory such as RAM, and non-volatile memory such as a flash memory or peripheral storage devices such as hard disks and optical disks.

The foregoing description relates to preferred embodiments of the invention. However, those having ordinary skill in the art will recognize a variety of alternative organizations and implementations that fall within the spirit and scope of the invention as defined by the following claims.

What is claimed is:

1. A system for assisting a user to select options for a configurable product, the configurable product having a set of attributes and each attribute having a set of options associated therewith, the system comprising:
at least one processor to execute programming instructions;
exclusion rules defining exclusions of options by other options; and
a storage device coupled to the at least one processor and having stored therein programming instructions to be executed by the processor to perform processing comprising:
receiving a set of selected options selected by a user of the system;
determining available options in view of the selected options, wherein available options consist of options that are not directly excluded by the selected options and that are not commonly excluded by options remaining in view of directly excluded options; and
generating a user interface representing the available options.

2. The system recited in claim 1, wherein, if the set of selected options includes a selected option for each of said attributes, said processing further comprises determining a product number corresponding to the set of selected options.

3. The system recited in claim 2, wherein the system further comprises exclusion rules defining exclusions of product number field values by options, and
wherein determining a product number comprises:
applying exclusion rules to said selected options to determine nonexcluded field values, and
combining the nonexcluded field values to form a product number.

4. The system recited in claim 2, the configurable product being assembled from a set of component types and each component type having a set of components associated therewith, wherein the system further comprises exclusion rules defining exclusions of product number field values by options, and exclusion rules defining exclusions of product number field values by components, and wherein determining a product number comprises:
applying exclusion rules to said selected options and an associated set of nonexcluded components to determine nonexcluded field values, and
combining the nonexcluded field values to form a product number.

5. The system recited in claim 1, the configurable product being assembled from a set of component types and each component type having a set of components associated therewith, wherein the system further comprises exclusion rules defining exclusions of components by options and exclusion rules defining exclusions of components by other components, and wherein determining available options comprises:
excluding options and components directly excluded by the selected options; and
iteratively excluding options and components that are commonly excluded by nonexcluded options associated with the same attribute, and options and components commonly excluded by nonexcluded components associated with the same component type.

6. The system recited in claim 1, wherein the system further comprises exclusion rules defining exclusions of options by components, and exclusion ruled defining exclusions of components by components.

7. A method for assisting a user to select options for a configurable product, the configurable product having a set of attributes and each attribute having a set of options associated therewith, the method comprising:
receiving a set of selected options selected by a user of the system;
determining available options in view of the selected options, wherein available options consist of options that are not directly excluded by the selected options and that are not commonly excluded by options remaining in view of directly excluded options; and
generating a user interface representing the available options.

8. The method recited in claim 7, wherein, if the set of selected options includes a selected option for each of said attributes, said processing further comprises determining a product number corresponding to the set of selected options.

9. The method recited in claim 8, wherein determining a product number comprises:
applying exclusion rules to said selected options to determine nonexcluded product number field values, said exclusion rules defining exclusions of product number field values by options, and
combining the nonexcluded field values to form a product number.

10. The method recited in claim 8, wherein determining a product number comprises:
applying exclusion rules to said selected options and an associated set of nonexcluded components to determine nonexcluded field values, said exclusion rules including rules defining exclusions of product number field values by options, and rules defining exclusions of product number field values by components, the configurable product being assembled from a set of component types and each component type having a set of components associated therewith, and
combining the nonexcluded field values to form a product number.

11. The method recited in claim 7, the configurable product being assembled from a set of component types and each component type having a set of components associated therewith, wherein determining available options further comprises:
excluding options and components directly excluded by the selected options; and
iteratively excluding options and components commonly excluded by nonexcluded options associated with the same attribute, and options and components commonly excluded by nonexcluded components associated with the same component type.

12. The method recited in claim 7, wherein determining available options comprises applying exclusion rules defining exclusions of options by options, exclusion rules defining exclusions of options by components, and exclusion ruled defining exclusions of components by components.

13. A maintenance process for a server in a system for configuring a product, the product having a set of attributes and each attribute having a set of options associated therewith, the process comprising:
generating a set of arbitrary product numbers;
discarding invalid product numbers;
discarding product numbers requiring unavailable components;
obtaining for each product number a set of components and options associated with the product number; and
creating exclusion rules indicating, for each given option present in any set associated with any product number, each option not present in conjunction with said given option in any set associated with any product number.

14. The maintenance process claimed in claim 13, said product being assembled from a set of component types and each component type having a set of components associated therewith, wherein said created exclusion rules further indicate, for each given option present in any set associated with any product number, each component not present in conjunction with said given option in any set associated with any product number, and for each given component present in any set associated with any product number, each option and each component not present in conjunction with said given component in any set associated with any product number.

15. The maintenance process recited in claim 14, further comprising creating exclusion rules indicating, for each given option present in any set associated with any product number, each product number field value not present in any product number in conjunction with said given option, and for each given component present in any set associated with any product number, each product number field value not present in any product number in conjunction with said given component.

16. The maintenance process recited in claim 14, wherein product numbers requiring unavailable components are determined in accordance with a component database of a configurator, and
wherein a set of components and options associated with each product number is obtained from said configurator in accordance with said component database and an option database of said configurator.

17. The maintenance process recited in claim 16, wherein discarding product numbers requiring unavailable components and obtaining a set of components and options for each product number are performed subsequent to updating of at least one of said option database and said component database, whereby changes to said at least one of said option database and said component database are reflected in said exclusion rules.

18. The maintenance process recited in claim 13, further comprising creating exclusion rules indicating, for each given option present in any set associated with any product number, each product number field value not present in any product number in conjunction with said given option.

19. A user interface for a system for configuring a configurable product, the configurable product having a set of attributes and each attribute having a set of options associated therewith, the user interface comprising:
the set of product attributes; and
a set of available options corresponding to a selected attribute, the set of available options consisting of options associated with the selected attribute that are not directly excluded by selected options associated with other product attributes and that are not commonly excluded by options remaining in view of selected options associated with other product attributes.

20. The user interface recited in claim 19, configurable product being assembled from a set of component types and each component type having a set of components associated therewith, wherein said set of available options consists of options associated with the selected attribute that are not directly excluded by selected options associated with other product attributes, that are not commonly excluded by options remaining in view of selected options associated with other product attributes, and that are not commonly excluded by components remaining in view of the selected options.

21. The user interface recited in claim 19, wherein said user interface is provided to a user through the Internet.
